(19) United States
(12) Patent Application Publication
(10) Pub. No.: US 2015/0304817 A1
(43) Pub. Date: Oct. 22, 2015

(54) MOBILE COMMUNICATION DEVICE AND COMMUNICATION CONTROL METHOD

(71) Applicant: SANYO ELECTRIC CO., LTD., Moriguchi-shi, Osaka (JP)

(72) Inventor: Yuki YORIFUJI, Aichi (JP)

(73) Assignee: SANYO ELECTRIC CO., LTD., Moriguchi-shi, Osaka (JP)

(21) Appl. No.: 14/367,795

(22) PCT Filed: Oct. 25, 2012
(86) PCT No.: PCT/JP2012/077531

§ 371 Date: Jun. 20, 2014

(30) Foreign Application Priority Data
Dec. 22, 2011 (JP) 2011-281819

(51) Int. Cl. H04W 4/02; H04L 29/08

(52) U.S. Cl. CPC H04W 4/027; H04L 67/12; H04W 88/02

(57) ABSTRACT

Provided are a mobile communication device and communication control method for imposing a limitation so that, under a situation in which transmission and/or reception of information to and/or from another communication device is unnecessary, the transmission and/or reception of the information to and/or from the another communication device is not carried out to avoid unnecessary transmission/reception of the information, to thereby reduce a power consumption. The mobile communication device, which is provided in a mobile object, includes: a movement detection sensor for detecting movement of the mobile object; a communication unit for communicating to/from another communication device; and a control unit for determining whether the mobile object is moving or not based on an output of the movement detection sensor, in which the control unit transmits and/or receives information to and/or from the another communication device through the communication unit only when determining that the mobile object is moving.

### TECHNICAL FIELD

The present invention relates to a mobile communication device and communication control method for performing predetermined control in order to prevent collision between mobile objects.

### BACKGROUND ART

Researches and developments have been made on intelligent transport systems (hereinafter referred to as “ITS”) aiming at solving road traffic problems such as traffic accidents and congestion through information networking among people, roads, and vehicles by using the information communication technology. In the ITS, particularly, the modes of pedestrian wireless communications in the field that deals with safe driving support systems can be roughly classified into a road-to-pedestrian communication and a pedestrian-to-vehicle (pedestrian-to-pedestrian) communication. The road-to-pedestrian communication permits roadside devices to communicate information to/from pedestrians, whereas the pedestrian-to-vehicle (pedestrian-to-pedestrian) communication permits pedestrians to directly communicate information to/from vehicles (or pedestrians). Further, the modes of automotive wireless communications can be roughly classified into a road-to-vehicle communication and a vehicle-to-vehicle (vehicle-to-pedestrian) communication. The road-to-vehicle communication permits roadside devices to communicate information to/from vehicles, whereas the vehicle-to-vehicle (vehicle-to-pedestrian) communication permits vehicles to directly communicate information to/from other vehicles (or pedestrians).

Information to be transmitted to pedestrians from roadside devices through the road-to-pedestrian communication includes intersection information and traffic signal information. The intersection information includes identification information for identifying an intersection, and the traffic signal information includes, for example, identification information for identifying a traffic signal.

Mobile object information of the vehicle, which is to be transmitted from one vehicle to another vehicle through the vehicle-to-vehicle communication includes information indicating the current position, moving speed, traveling direction, and the like of the vehicle. Mobile object information of the pedestrian, which is to be transmitted from the pedestrian to the vehicle through the pedestrian-to-vehicle communication includes information indicating the current position, moving speed, traveling direction, and the like of the pedestrian. (The same applies to the vehicle-to-pedestrian and pedestrian-to-pedestrian communications.)

Consideration has been given to such a configuration that whether or not collision is to occur is determined based on the mobile object information of the vehicle and the mobile object information of the pedestrian, and when there is a risk of collision (accident), predetermined control is performed, to thereby prevent a collision accident from occurring.

For example, a vehicle approach warning system disclosed in Patent Literature 1 includes: a mobile warning terminal to be carried by a pedestrian; and an in-vehicle communication device to be mounted to a vehicle, and the mobile warning terminal determines whether or not a field intensity at a time of receiving vehicle travel data, which has been transmitted wirelessly from the in-vehicle communication device, is larger than a threshold P, and when the field intensity is larger than the threshold P, the mobile warning terminal warns the pedestrian that the vehicle is approaching because the position of the vehicle is close to the pedestrian.

### CITATION LIST

### Patent Literature

[PTL 1] JP 2011-138476 A

### SUMMARY OF INVENTION

### Technical Problem

According to Patent Literature 1, the approach of the vehicle is detected and the pedestrian is warned of the approach, and hence the collision accident can be prevented from occurring. However, it cannot be known when the risk of a collision accident occurs, and hence a communication unit communicates to/from another communication device at all times, with the result that a power consumption amount increases. In particular, a mobile communication terminal carried by the pedestrian is powered by a battery, and hence it is not desired that the mobile communication terminal communicate to/from another communication device at all times. Moreover, it is desired that the power consumption of the in-vehicle device to be mounted to the vehicle also be reduced.

In view of the above-mentioned problem, the present invention has an object to provide a mobile communication device and communication control method for imposing a limitation so that, under a situation in which transmission and/or reception of information to and/or from another communication device is unnecessary, the transmission and/or reception of the information to and/or from the another communication device is not carried out to avoid unnecessary transmission/reception of the information, to thereby reduce a power consumption.

### Solution to Problem

In order to achieve the above-mentioned object, according to one embodiment of the present invention, there is provided a mobile communication device, which is provided in a mobile object, including: a movement detection sensor for detecting movement of the mobile object; a communication unit for communicating to/from another communication device; and a control unit for determining whether or not the mobile object is moving based on an output of the movement detection sensor, in which only when determining that the mobile object is moving, the control unit transmits and/or receives information to and/or from the another communication device through the communication unit.

Further, in the mobile communication device having the above-mentioned structure, it is desired that the control unit further determine whether or not a current position of the mobile object is near an intersection, and only when the mobile object is moving and the current position of the mobile object is near the intersection, transmit and/or receive the information to and/or from the another communication device through the communication unit.

Further, in the mobile communication device having the above-mentioned structure, it is desired that the mobile object be a pedestrian, and the control unit determine whether or not the pedestrian rides in a vehicle. It is desired that when the pedestrian rides in the vehicle, the control unit avoid the transmission and/or reception of the information to and/or from the another communication device through the communication unit irrespective of whether or not the pedestrian is moving.

Further, in the mobile communication device having the above-mentioned structure, it is desired that the mobile object be a pedestrian, and the control unit determine whether or not the pedestrian is operating the mobile communication device. It is desired that when the pedestrian is not operating the mobile communication device, the control unit avoid the transmission and/or reception of the information to and/or from the another communication device through the communication unit irrespective of whether or not the pedestrian is moving.

Further, in the mobile communication device having the above-mentioned structure, it is desired that based on the information acquired from the another communication device through the communication unit, the control unit give, through a notification unit, a notification that there is a risk that the mobile object collides with another mobile object including the another communication device.

Further, in the mobile communication device having the above-mentioned structure, it is desired that the mobile object be a pedestrian, and the control unit determine whether or not the another mobile object is the pedestrian. It is desired that when the another mobile object is the pedestrian, the control unit avoid giving a notification that there is a risk that the mobile object collides with the another mobile object.

Further, in the mobile communication device having the above-mentioned structure, it is desired that the control unit stop feeding power to the communication unit, to thereby avoid the transmission and reception of the information to and from the another communication device through the communication unit.

In order to achieve the above-mentioned object, according to one embodiment of the present invention, there is provided a communication control method, including the steps of: determining whether or not a mobile object is moving based on an output of a movement detection sensor for detecting movement of the mobile object; and transmitting and/or receiving information to and/or from another communication device through a communication unit only when the mobile object is moving.

### Advantageous Effects of Invention

According to one embodiment of the present invention, under a situation in which transmission and/or reception of information to and/or from another communication device is unnecessary, the transmission and/or reception of the information to and/or from the another communication device is limited to avoid unnecessary transmission/reception of the information, to thereby reduce a power consumption.

### BRIEF DESCRIPTION OF DRAWINGS

FIG. 1 is a block diagram illustrating a configuration of a mobile phone according to the present invention.

FIG. 2 is a first flow chart illustrating a flow of processing performed by a control unit of the mobile phone according to the present invention.

FIG. 3 is a second flow chart illustrating a flow of processing performed by the control unit of the mobile phone according to the present invention.

FIG. 4 is a third flow chart illustrating a flow of processing performed by the control unit of the mobile phone according to the present invention.

FIG. 5 is a fourth flow chart illustrating a flow of processing performed by the control unit of the mobile phone according to the present invention.

FIG. 6 is a fifth flow chart illustrating a flow of processing performed by the control unit of the mobile phone according to the present invention.

FIG. 7 is a sixth flow chart illustrating a flow of processing performed by the control unit of the mobile phone according to the present invention.

### DESCRIPTION OF EMBODIMENTS

Now, a description is given of embodiments of the present invention with reference to the drawings. Note that, in order to embody a technical idea of the present invention, the embodiments to be described below describe a mobile phone as a mobile communication terminal, which is an example of a mobile communication device according to the present invention, and are not intended to specify the present invention as the mobile phone and are also equally applicable to devices of other embodiments included in Scope of Claims. Further, the following description takes a case where a pedestrian carries the mobile phone as an example, but the mobile phone may be mounted to a bicycle, a motorcycle, or the like.

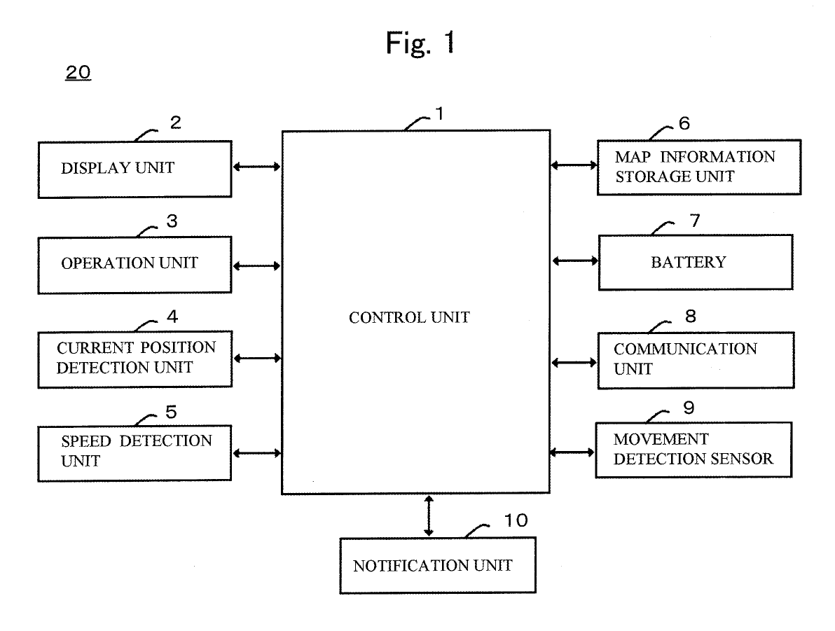

FIG. 1 is a block diagram illustrating the configuration of a mobile phone 20 of the present invention. The mobile phone 20 includes a control unit 1, a display unit 2, an operation unit 3, a current position detection unit 4, a speed detection unit 5, a map information storage unit 6, a battery 7, a communication unit 8, a movement detection sensor 9, and a notification unit 10.

The control unit 1 is control means for generally controlling the overall mobile phone 20. The control unit 1 includes a CPU, a ROM, and a RAM (none shown). Stored in the ROM are programs that are executed by the control unit 1, and parameters and data that are necessary for executing the programs. The CPU executes various programs stored in the ROM. The RAM temporarily stores data obtained in the course of performing various processes, and data obtained as a result of performing various processes. These CPU, RAM, ROM, etc. are interconnected by buses. The CPU, ROM, and RAM may be partially or entirely integrated into a single chip.

The display unit 2 is display means for displaying a map screen (screen showing a map image including a route to a destination, and a mark indicative of the current position of a pedestrian carrying the mobile phone 20 (in the following, “pedestrian carrying a mobile communication terminal such as a mobile phone” may be called “pedestrian”)), and a menu screen.

The operation unit 3 is input operation means for allowing a user to input a destination and operate the menu. As the operation unit 3, various keys and buttons may be provided on the main body of the mobile phone 20, or the display unit 2 may be provided with a touch panel function.

The current position detection unit 4 detects the current position of the pedestrian, and is configured to include a GPS receiver, self-contained navigation means, and a CPU for calculating the position. The self-contained navigation means includes an acceleration sensor, a distance sensor, and an azimuth sensor to detect the traveling distance and the traveling direction of the pedestrian, and obtain the current position thereof based on these values. Further, the GPS receiver receives radio waves transmitted from a plurality of GPS satellites by a GPS antenna, and calculates the absolute position and the traveling direction of the pedestrian by performing three-dimensional positioning or two-dimensional positioning. The traveling direction is calculated based on the current position of the pedestrian and the previous position of the pedestrian. The method of detecting the traveling direction is not particularly limited, and may be detected using the azimuth sensor, for example. Further, a traveling-direction detection unit may be provided in addition to the current position detection unit 4 to detect the traveling direction of the pedestrian.

The speed detection unit 5 detects the moving speed of the pedestrian. The moving speed may be calculated from the output of a speed sensor or the acceleration sensor, or may be calculated from the difference in the moving distance and in the time of GPS reception between the GPS histories. The moving speed of the pedestrian may be detected by the current position detection unit 4. When the current position detection unit 4 can detect the moving speed in addition to the current position of the pedestrian, the speed detection unit 5 may not be provided separately. In this case, the current position detection unit 4 is configured to include the speed detection unit 5.

Map information which is referred to when performing route search to a destination or navigation and information indicating that a specific point on the map information is the position of the user's home or company are stored in the map information storage unit 6. The map information includes network data (node data and link data). A NAND flash memory, an SD memory card, or the like can be suitably used as the map information storage unit 6. The map information storage unit 6 may be built in the mobile phone 20, or may be detachably mounted to the mobile phone 20. Further, the map information may include map images, or map images may be rendered on the display unit 2 based on the network data (node data and link data) included in the map information. Instead of being stored in the map information storage unit 6 in advance, map information may be received from roadside devices or the like by the communication unit 8 to be described later, and the received map information may be stored in the map information storage unit 6.

The map information includes the network data, and the network data includes the node data where node points such as a bending point and junction point of a road and sidewalk are defined as nodes and the link data where a route connecting the nodes is defined as a link. The node data includes node attributes such as a node number, position coordinates (latitude/longitude) of the node, a road type/sidewalk type, and information indicating intersection information, intersection name, and the like, and further includes data on the number of links connected and link numbers of the connected links.

The link data includes data on node numbers as start and end points of the link, a road type/sidewalk type (such as ordinary road, expressway, ordinary sidewalk, pedestrian walkway, crosswalk, and footbridge), a link cost including a distance and/or a required time, a road name such as “Route_”, and a traveling direction. In addition to those pieces of data, the link data has added thereto data such as a bridge, a tunnel, a railroad crossing, and a tollgate as a link attribute.

In the present invention, the network data includes the node data and the link data of roads. In specifying a current position of the pedestrian, the control unit 1 can specify the current position by performing map matching based on the current position of the pedestrian detected by the current position detection unit 4 (traveling direction and moving speed may also be added) and map information.

Note that, the map matching process may be performed by the control unit 1 or may be performed by the current position detection unit 4. In other words, map matching may be performed based on the current position detected by using the GPS receiver and/or the self-contained navigation means and the map information, and the current position obtained through map matching may be output as the current position to the control unit 1. Alternatively, the current position detection unit 4 may include the map matching process of the control unit 1.

The battery 7 is power supply means for the mobile phone 20, and a secondary battery such as a lithium-ion battery or a nickel hydride battery may be used suitably. Of course, a primary battery such as an alkali manganese dry cell or a manganese dry cell may be used as the battery 7, or a fuel cell may be used as well.

The communication unit 8 includes a transmission unit (not shown) that transmits information to another communication device (hereinafter referred to as “another communication device”) that can communicate to/from the mobile phone 20, and a reception unit (not shown) that receives information transmitted from the another communication device. The communication method is preferred to be non-contact communication such as wireless communication and infrared communication. Examples of the another communication device include an in-vehicle communication device such as a navigation device mounted on a vehicle (which may be a mobile communication terminal, such as a mobile phone, which is carried by another pedestrian when the another pedestrian is on the vehicle), a roadside device, and a mobile communication terminal such as a mobile phone carried by another pedestrian or the like (pedestrian, the driver of a bicycle, or the like).

Information received by the communication unit 8 from the in-vehicle communication device and the mobile communication terminal includes mobile object information of the mobile object. A description is given below of the mobile object information of the mobile object. In a case where the mobile object is the pedestrian, that is, in a case where the mobile object information is the mobile object information of the pedestrian, the mobile object information includes information indicating the current position, traveling direction, and moving speed of the pedestrian carrying the mobile communication terminal. Further, in a case where the mobile object is the vehicle, that is, in a case where the mobile object information is the mobile object information of the vehicle, the mobile object information includes information indicating the current position, traveling direction, and moving speed of the vehicle having the in-vehicle communication device, such as a navigation device, mounted thereto (“vehicle having the in-vehicle communication device, such as a navigation device, mounted thereto” is hereinafter sometimes referred to as “vehicle”).

Note that, the current position of the pedestrian or vehicle may be the current position obtained after the map matching or may be the current position obtained before the map matching (current position positioned by the GPS receiver). In the case where the current position of the pedestrian or vehicle is the current position obtained before the map matching, the control unit 1 (current position detection unit 4) may perform the map matching.

The movement detection sensor 9 is a sensor for detecting the movement of the mobile phone 20 (pedestrian). Examples of the movement detection sensor include an acceleration sensor, a vibration sensor, an angular velocity sensor, and a pedometer. Note that, in the configuration described herein, the movement detection sensor 9 is separately provided in order to simplify the description, but the present invention is not limited to this configuration. For example, in the case where the acceleration sensor is used as the movement detection sensor 9, the movement detection sensor 9 may be included in the current position detection unit 4 as described above.

The notification unit 10 gives a notification of various kinds of information in a predetermined manner. A mode of giving the notification is not particularly limited, but a mode suitable for carrying out such support as to prevent collision with another mobile object is desired. For example, the notification is given by outputting, through a speaker (not shown), an alarm sound indicating that there is an imminent risk of collision, vibrating the mobile phone 20 by a predetermined vibration method with a vibration function, or performing predetermined display on the display unit 2. Alternatively, the notification may be given by carrying out a combination of those notification methods or simultaneously carrying out those notification methods. The notification unit 10 and the display unit 2 are provided as separate components in order to simplify the description, but in a case where the notification method includes performing of the predetermined display on the display unit 2, the notification unit 10 may include the display unit 2.

### First Embodiment

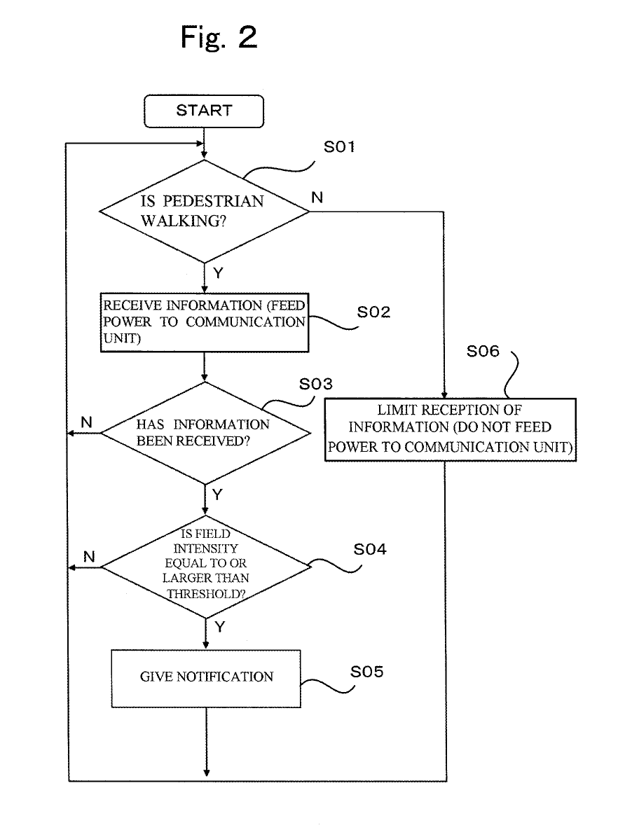

A mobile communication device according to a first embodiment of the present invention is described referring to FIG. 2. FIG. 2 is a first flow chart illustrating a flow of processing performed by the control unit 1 of the mobile phone 20 according to the present invention. The flow chart of this embodiment is a flow chart illustrating processing performed in a case where, when the communication unit 8 receives information from the in-vehicle communication device mounted to the vehicle, which is an example of the another communication device, a notification indicating that there is a risk of collision is given to the pedestrian. Further, it is assumed in this embodiment that the control unit 1 receives the information through the communication unit 8 only when the pedestrian is walking, and limits the reception of the information through the communication unit 8 when the pedestrian is not walking. A method of limiting the reception of the information is not particularly limited, and in a case where the reception of the information is to be limited, the control unit 1 only needs to stop feeding power to the communication unit 8 (reception unit). Note that, in this embodiment, when the pedestrian is not walking, the need to receive the information from the another communication device (in-vehicle communication device) is low because the pedestrian is less likely to collide with the vehicle by, for example, running out into a road, and hence it is desired that the reception of the information be at least limited.

In Step S01, the control unit 1 determines whether or not the pedestrian carrying the mobile phone 20 is walking based on an output of the movement detection sensor 9. For example, in a case where the vibration sensor is used as the movement detection sensor 9, it is determined that the pedestrian is walking (moving) when the vibration is currently detected, and it is determined that the pedestrian is not walking (stands still) when the vibration is not currently detected.

Similarly, in a case where the acceleration sensor is used as the movement detection sensor 9, the control unit 1 determines whether or not the pedestrian is walking based on an output of the acceleration sensor, specifically, based on whether or not an acceleration value output from the acceleration sensor is equal to or larger than a predetermined value. Note that, various known methods can be used for the method of determining whether or not the pedestrian is walking based on the output of the vibration sensor or acceleration sensor.

When the pedestrian is walking (Y in Step S01), the processing proceeds to Step S02, and when the pedestrian is not walking (N in Step S01), the processing proceeds to Step S06. First, a description is given of a case where the processing proceeds to Step S02.

In Step S02, the control unit 1 receives the information through the communication unit 8. In the case where, as described in this embodiment, the control unit 1 stops feeding power to the communication unit 8 when the pedestrian is not walking, the control unit 1 feeds power to the communication unit 8, to thereby receive the information.

Next, in Step S03, the control unit 1 determines whether or not the information has been received from the another communication device (in this embodiment, the in-vehicle communication device) with the ITS communication (whether or not the information has been received through the communication unit 8). When the information has been received from the another communication device with the ITS communication (Y in Step S03), the processing proceeds to Step S04, and when the information has not been received from the another communication device with the ITS communication (N in Step S03), the processing returns to Step S01.

In Step S04, the control unit 1 specifies a field intensity at the time of receiving the information, and determines whether or not the specified field intensity is larger than a predetermined threshold. When the field intensity is larger than the predetermined threshold (Y in Step S04), it is conceivable that the distance between the vehicle and the pedestrian is small, and hence the processing proceeds to Step S05. In Step S05, the control unit 1 gives a notification indicating that the vehicle is approaching the pedestrian (that there is a risk that the pedestrian may collide with the vehicle) through the notification unit 10, and then the processing returns to Step S01. When the field intensity is not larger than the predetermined threshold (N in Step S04), the processing returns to Step S01.

Next, a description is given of a case where the processing proceeds to Step S06 after it is determined in Step S01 that the pedestrian is not walking.

In Step S06, the control unit 1 limits the reception of the information through the communication unit 8. To be specific, the control unit 1 stops feeding power to the communication unit 8 (reception unit), to thereby bring the mobile phone 20 into a state in which the mobile phone 20 cannot receive the information through the communication unit 8.

According to this embodiment, when the pedestrian is not walking, the mobile communication terminal carried by the pedestrian does not receive the information. In other words, while the pedestrian stops, a risk that a collision accident occurs the moment the pedestrian and the vehicle meet is low, and hence the need to notify the pedestrian that there is a risk of collision is low even if the vehicle is approaching the pedestrian. In view of this, by limiting unnecessary reception of the information in such case, it is possible to reduce the power consumption.

Note that, in this embodiment, the reception of the information through the communication unit 8 is limited when the pedestrian is not walking, but the mobile phone 20 may continue the transmission of the information through the communication unit 8 even during this period of time.

In other words, the mobile phone 20 may be configured so that the mobile phone 20 transmits the information through the communication unit 8 at all times when the power of the mobile phone 20 is on, but receives the information only when the pedestrian is walking.

The mobile phone 20 continues the transmission irrespective of whether or not the pedestrian is walking so that it is possible to notify the owner of the another communication device (in this embodiment, the in-vehicle communication device) that there is a pedestrian carrying the mobile phone 20.

Alternatively, the mobile phone 20 may be configured so that the mobile phone 20 does not transmit the information through the communication unit 8 at any time when the power of the mobile phone 20 is on, and receives the information only when the pedestrian is walking. When the mobile phone 20 does not transmit the information irrespective of whether or not the pedestrian is walking, it is possible to reduce the power consumption.

### Second Embodiment

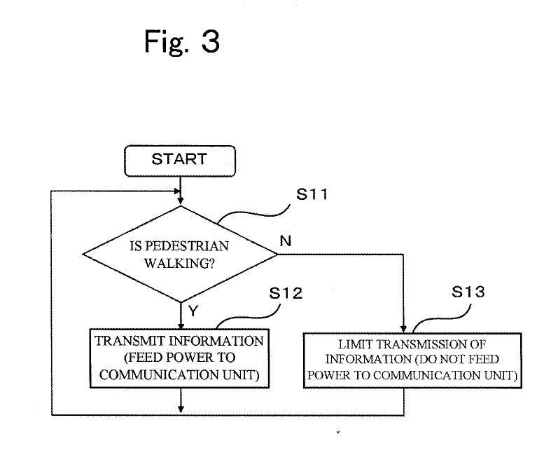

A mobile communication device according to a second embodiment of the present invention is described referring to FIG. 3. FIG. 3 is a second flow chart illustrating a flow of processing performed by the control unit 1 of the mobile phone 20 according to the present invention. The flow chart of this embodiment is a flow chart illustrating processing performed in a case where the communication unit 8 transmits information on the mobile phone 20 to the in-vehicle communication device mounted to the vehicle, which is an example of the another communication device. Further, it is assumed in this embodiment that the control unit 1 transmits the information through the communication unit 8 only when the pedestrian is walking, and limits the transmission of the information through the communication unit 8 when the pedestrian is not walking. A method of limiting the transmission of the information is not particularly limited as in the first embodiment. Further, in this embodiment, when the pedestrian is not walking, there is no need to transmit the information to the another communication device because the pedestrian is less likely to collide with the vehicle by, for example, running out into a road, and hence it is desired that the transmission of the information be at least limited.

In Step S11, the control unit 1 determines whether or not the pedestrian carrying the mobile phone 20 is walking based on the output of the movement detection sensor 9. When the pedestrian is walking (Y in Step S11), the processing proceeds to Step S12, and when the pedestrian is not walking (N in Step S11), the processing proceeds to Step S13.

In Step S12, the control unit 1 transmits the information through the communication unit 8. When the pedestrian is walking, the control unit 1 transmits the information through the communication unit 8 regularly (every 0.1 second, for example).

On the other hand, in Step S13, the control unit 1 limits transmission of the information through the communication unit 8. To be specific, the control unit 1 stops feeding power to the communication unit 8, to thereby bring the mobile phone 20 into a state in which the mobile phone 20 cannot transmit the information through the communication unit 8. Alternatively, the control unit 1 does not merely transmit the information through the communication unit 8, to thereby limit the transmission of the information through the communication unit 8.

According to this embodiment, when the pedestrian is not walking, the mobile communication terminal carried by the pedestrian does not transmit the information. In other words, while the pedestrian stops, a risk that a collision accident occurs the moment the pedestrian and the vehicle meet is low, and hence the need to transmit the information on the pedestrian to the vehicle is low. In view of this, by limiting unnecessary transmission of the information in such case, it is possible to reduce the power consumption.

Note that, in this embodiment, the transmission of the information through the communication unit 8 is limited when the pedestrian is not walking, but the mobile phone 20 may continue the reception of the information through the communication unit 8 even during this period of time.

In other words, the mobile phone 20 may be configured so that the mobile phone 20 receives the information through the communication unit 8 at all times when the power of the mobile phone 20 is on, but transmits the information only when the pedestrian is walking.

The mobile phone 20 continues the reception irrespective of whether or not the pedestrian is walking to carry out the operation corresponding to the first embodiment. When the another communication device (in this embodiment, the in-vehicle communication device) is approaching the pedestrian, it is possible to notify the pedestrian that there is an in-vehicle communication device (that is, the vehicle).

Alternatively, the mobile phone 20 may be configured so that the mobile phone 20 does not receive the information through the communication unit 8 at any time when the power of the mobile phone 20 is on, and transmits the information only when the pedestrian is walking. When the mobile phone 20 does not receive the information irrespective of whether or not the pedestrian is walking, it is possible to reduce the power consumption.

Note that, the first and second embodiments described above may be combined with each other. In other words, the mobile phone 20 may be configured so that the control unit 1 determines whether or not the pedestrian carrying the mobile phone 20 is walking based on the output of the movement detection sensor 9, and when the pedestrian is walking, the control unit 1 transmits and receives the information through the communication unit 8, and when the pedestrian is not walking, the control unit 1 limits the transmission and reception of (does not transmit or receive) the information through the communication unit 8.

The control unit 1 transmits and receives the information when the pedestrian is walking and does not transmit or receive the information when the pedestrian is not walking so that, when the pedestrian is walking (moving) and thus there is a risk that a collision accident may occur, it is possible to notify the pedestrian that there is an in-vehicle communication device (that is, the vehicle) and also possible to notify the owner of the another communication device (in this embodiment, the in-vehicle communication device) that there is a pedestrian carrying the mobile phone 20.

Further, a risk of occurrence of a collision accident is low while the pedestrian stops, and hence it is possible to reduce the power consumption by limiting the transmission and reception of the information.

### Third Embodiment

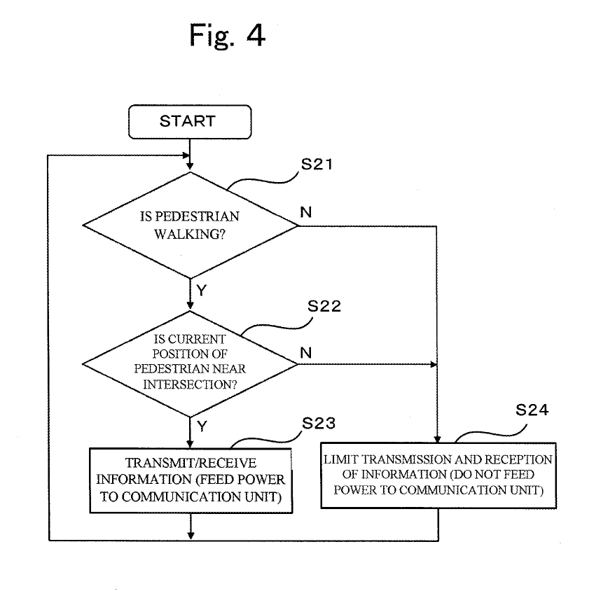

A mobile communication device according to a third embodiment of the present invention is described referring to FIG. 4. FIG. 4 is a third flow chart illustrating a flow of processing performed by the control unit 1 of the mobile phone 20 according to the present invention. Note that, descriptions of Steps S21, S23, and S24 of this embodiment are similar to the descriptions of Steps S01 (S11), S02 (S12), and S06 (S13) of the first and second embodiments, respectively, and hence their descriptions are omitted.

Note that, the embodiment to be described below takes as an example a case where the mobile phone 20 transmits and receives the information when the pedestrian is walking and does not transmit or receive the information when the pedestrian is not walking.

In Step S22, the control unit 1 determines whether or not the current position of the mobile phone 20 (the pedestrian carrying the mobile phone 20) is near an intersection. The control unit 1 acquires current position coordinates of the mobile phone 20 (the pedestrian carrying the mobile phone 20) from the current position detection unit 4, and acquires position coordinates of the intersection from the map information stored in the map information storage unit 6. When “the current position of the mobile phone 20 (the pedestrian carrying the mobile phone 20) is near the intersection,” this means that, for example, the current position coordinates of the mobile phone 20 (the pedestrian carrying the mobile phone 20) are within a predetermined range from the position coordinates of the intersection. When the current position of the mobile phone 20 (the pedestrian carrying the mobile phone 20) is near the intersection (Y in Step S22), the processing proceeds to Step S23, and when the current position of the mobile phone 20 (the pedestrian carrying the mobile phone 20) is not near the intersection (N in Step S22), the processing proceeds to Step S24.

Note that, in this embodiment, the control unit 1 acquires the position coordinates of the intersection from the map information stored in the map information storage unit 6, but the mobile phone 20 may be configured so that, in a case where the control unit 1 acquires the position coordinates of the intersection from the roadside device or the like through the communication unit 8, the control unit 1 performs this step after Step S23 (after having transmitted/received the information, that is, after having acquired the intersection information), and when the current position of the mobile phone 20 (the pedestrian carrying the mobile phone 20) is near the intersection, the control unit 1 continues transmitting/receiving the information, and when the current position of the mobile phone 20 (the pedestrian carrying the mobile phone 20) is not near the intersection, the processing proceeds to Step S24.

According to this embodiment, effects similar to those of the first and second embodiments are achieved. Further, according to this embodiment, when the current position of the pedestrian carrying the mobile communication terminal is not near the intersection, the mobile communication terminal carried by the pedestrian does not transmit and/or receive the information. In other words, when the current position of the pedestrian is not near the intersection, a risk that a collision accident may occur the moment the pedestrian and the vehicle meet is low, and hence the need to transmit the information on the pedestrian to the vehicle is low. In view of this, by limiting unnecessary transmission/reception of the information in such case, it is possible to reduce the power consumption.

### Fourth Embodiment

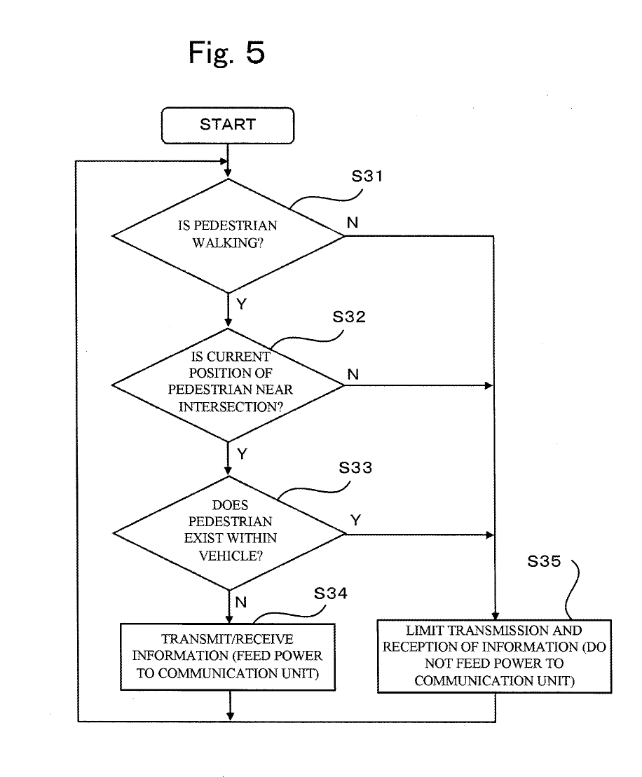

A mobile communication device according to a fourth embodiment of the present invention is described referring to FIG. 5. FIG. 5 is a fourth flow chart illustrating a flow of processing performed by the control unit 1 of the mobile phone 20 according to the present invention. Note that, Steps S31, S32, S34, and S35 of this embodiment are similar to Steps S21, S22, S23, and S24 of the third embodiment, respectively, and hence their descriptions are omitted.

A case where the pedestrian carrying the mobile phone 20 rides in such a vehicle as an automobile, a bus, and a train is conceivable. In such case, the notification for notifying that there is an in-vehicle communication device (another vehicle) after receiving the information from the in-vehicle communication device or the transmission of the information from the mobile phone 20 (notifying that there is a pedestrian) annoys other fellow passengers or leads to a misunderstanding of a user of the in-vehicle communication device (another vehicle). Accordingly, not only when the power consumption is to be reduced, when the pedestrian carrying the mobile phone 20 rides in such a vehicle as an automobile, a bus, and a train, it is preferred that the mobile communication terminal not transmit and/or receive the information.

In Step S31, the control unit 1 determines whether or not the pedestrian carrying the mobile phone 20 is walking based on the output of the movement detection sensor 9.

In this determination, even when the passenger rides in such a vehicle as an automobile, a bus, and a train, vibration or acceleration may be applied to the mobile phone 20 owing to irregularity of a road surface or acceleration/deceleration of the vehicle and it is determined as a result that the pedestrian is walking.

For this reason, in Step S33, the control unit 1 determines whether or not the mobile phone 20 (the pedestrian carrying the mobile phone 20) exists within the vehicle (rides in the vehicle). As used herein, the vehicle refers to an automobile, a light vehicle, a motorcycle, and other such vehicles (the vehicle may be reworded as “conveyance” in a more general concept), and the determination in this step can be rephrased as “the control unit 1 determines whether or not the pedestrian is moving on foot.”

A method of determining whether or not the mobile phone 20 (the pedestrian carrying the mobile phone 20) exists within the vehicle is not particularly limited. As an example, the mobile phone 20 holds a correlation table of the acceleration value and the moving speed and makes the determination based on the correlation table (for example, when the acceleration value is 5 G and the moving speed is equal to or larger than 10 km/h, it is determined that the mobile phone 20 exists within the vehicle).

It is conceivable that in normal cases, when the pedestrian runs, the moving speed increases and at the same time, the vibration/acceleration also increases as a result of the running (in other words, when the pedestrian moves, the moving speed is proportional to the vibration value/acceleration value). In view of this, the mobile phone 20 holds the correlation table of the acceleration value and the moving speed, and when the vibration value/acceleration value is small as compared with the moving speed, determines that the mobile phone 20 (the pedestrian carrying the mobile phone 20) exists within the vehicle.

When the mobile phone 20 (the pedestrian carrying the mobile phone 20) exists within the vehicle (Y in Step S33), the processing proceeds to Step S35, and when the mobile phone 20 (the pedestrian carrying the mobile phone 20) does not exist within the vehicle (N in Step S33), the processing proceeds to Step S34.

Note that, similarly to the third embodiment, the mobile phone 20 may be configured so that the control unit 1 performs this step after Step S34 (after having transmitted/received the information, that is, after having acquired the intersection information), and when the mobile phone 20 (the pedestrian carrying the mobile phone 20) does not exist within the vehicle, the control unit 1 continues transmitting/receiving the information, and when the mobile phone 20 (the pedestrian carrying the mobile phone 20) exists within the vehicle, the processing proceeds to Step S35.

Note that, in the flow chart of FIG. 5, it is determined in Step S32 whether or not the current position of the mobile phone 20 is near the intersection, and when the current position of the mobile phone 20 is near the intersection, the processing proceeds to Step S33, but the processing of Step S32 is not always necessary. In other words, the fourth embodiment is not limited to the case where the current position is near the intersection.

According to this embodiment, effects similar to those of the first and second embodiments are achieved. Further, according to this embodiment, unless the pedestrian carrying the mobile communication terminal does not exist within the vehicle, the mobile communication terminal carried by the pedestrian does not transmit and/or receive the information. In other words, when the pedestrian carrying the mobile communication terminal exists within the vehicle, there is no need to notify the pedestrian (passenger) of a risk that a collision may occur the moment the pedestrian and the vehicle meet. In view of this, by limiting unnecessary transmission/reception of the information in such case, it is possible to reduce the power consumption.

### Fifth Embodiment

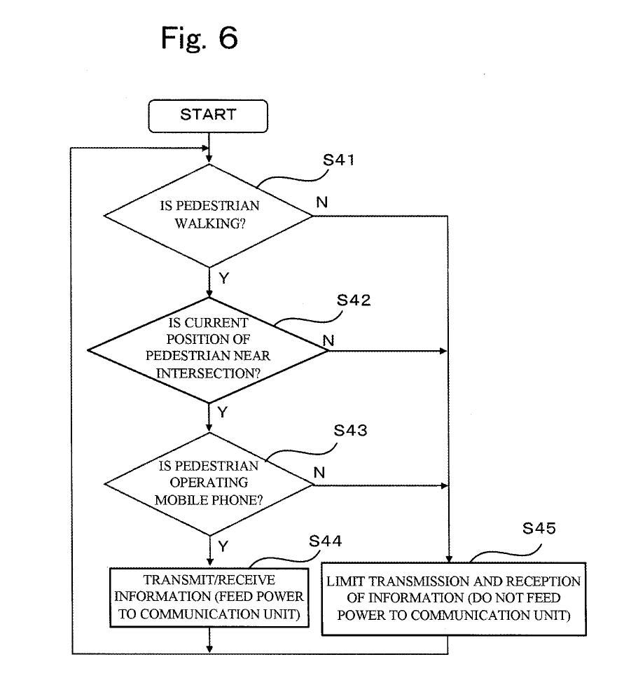

A mobile communication device according to a fifth embodiment of the present invention is described referring to FIG. 6. FIG. 6 is a fifth flow chart illustrating a flow of processing performed by the control unit 1 of the mobile phone 20 according to the present invention. Note that, Steps S41, S42, S44, and S45 of this embodiment are similar to Steps S21, S22, S23, and S24 of the third embodiment, respectively, and hence their descriptions are omitted.

In the first to third embodiments, the description has been given of the case where when the pedestrian (the pedestrian carrying the mobile phone 20) is walking, the mobile phone 20 transmits/receives the information assuming that there is a risk of collision. However, even when the pedestrian is walking, a risk of collision is low in a case where the pedestrian pays attention to his/her surroundings, and in this case, the need to transmit/receive the information is low.

In view of this, in the fifth embodiment, a description is given of a case where the mobile phone 20 transmits/receives the information only when the pedestrian is walking and the pedestrian is operating the mobile phone 20.

In Step S43, the control unit 1 determines whether or not the pedestrian is operating the mobile phone 20. In this embodiment, when “the pedestrian is operating the mobile phone 20,” this means a situation in which the pedestrian focuses his/her awareness to the mobile phone 20 and conceivably does not pay attention to a surrounding road situation. For example, when a video (for example, TV program) is being displayed on the display unit 2 of the mobile phone 20, when the operation unit 3 of the mobile phone 20 is being operated or a current time is within a predetermined period of time since the operation unit 3 is operated last, or when it is detected that the mobile phone 20 is being held by the pedestrian's hand, it is determined that the pedestrian is operating the mobile phone 20.

When the pedestrian is operating the mobile phone 20 (Y in Step S43), the processing proceeds to Step S44, and when the pedestrian is not operating the mobile phone 20 (N in Step S43), the processing proceeds to Step S45.

According to this embodiment, effects similar to those of the first and second embodiments are achieved. Further, according to this embodiment, when the pedestrian is not operating the mobile communication terminal, the mobile communication terminal carried by the pedestrian does not transmit and/or receive the information. In other words, when the pedestrian does not focus his/her awareness to the mobile communication terminal, that is, when the pedestrian conceivably pays attention to the surrounding road situation, a risk that a collision accident may occur the moment the pedestrian and the vehicle meet is low, and hence the need to transmit the information on the pedestrian to the vehicle is low even if the vehicle is approaching the pedestrian. In view of this, by limiting unnecessary transmission/reception of the information in such case, it is possible to reduce the power consumption.

Note that, when the pedestrian focuses his/her awareness to the mobile communication terminal, that is, when the pedestrian does not pay attention to the surrounding road situation, there is a risk of collision even if the pedestrian is not walking, and hence the mobile communication terminal may transmit/receive the information when the pedestrian is operating the mobile communication terminal (in other words, the mobile communication terminal may perform the processing from which Steps S41 and S42 are omitted).

### Sixth Embodiment

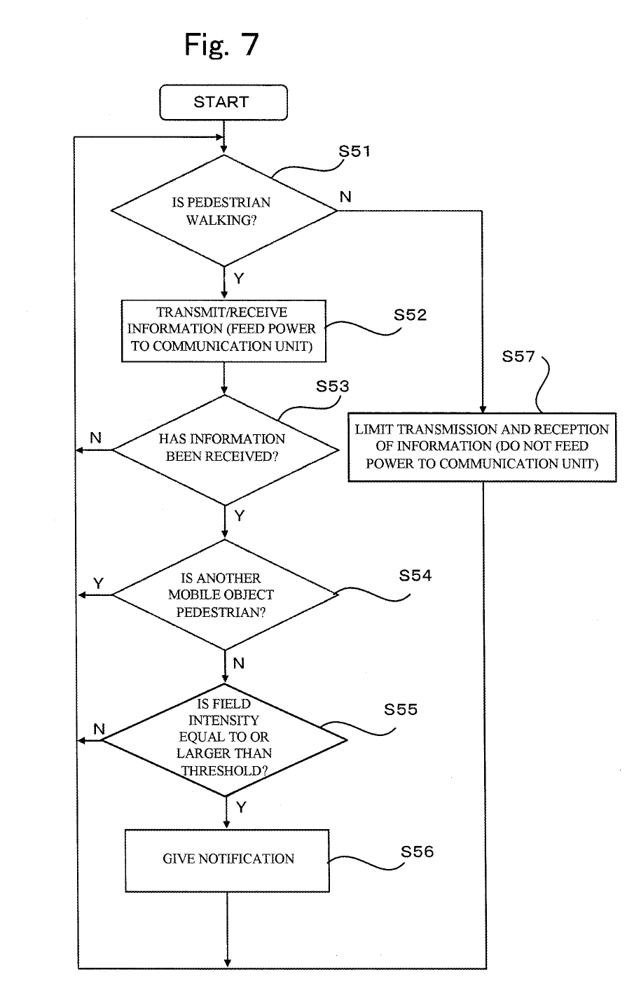

A mobile communication device according to a sixth embodiment of the present invention is described referring to FIG. 7. FIG. 7 is a sixth flow chart illustrating a flow of processing performed by the control unit 1 of the mobile phone 20 according to the present invention. Note that, Steps S51 to S53 and S55 to S57 of this embodiment are similar to Steps S01 to S03 and S04 to S06 of the first embodiment, respectively, and hence their descriptions are omitted.

In the embodiments described above, the in-vehicle communication device mounted to the vehicle has been taken as an example of the another communication device, but actually, the another communication device includes the roadside device and a mobile terminal carried by the pedestrian.

Accordingly, for example, even when the information has been received from the another communication device with the ITS communication and the field intensity is equal to or larger than the threshold, in a case of the approach between the pedestrians (the mobile phone 20 and the mobile terminal carried by the pedestrian), the need to give a notification is low.

Accordingly, in a case where the mobile object itself (the mobile terminal 20) is the mobile terminal (the terminal carried by the pedestrian), it is preferred that the mobile terminal determine whether or not another mobile object is the vehicle based on the received information, and give a notification through the notification unit 10 only when the another mobile object is the vehicle.

In view of this, in Step S54, the control unit 1 determines whether or not the another mobile object is the pedestrian based on the mobile object information of the another mobile object received in Step S53 from the another communication device. A method of determining whether or not the another mobile object is the pedestrian is not particularly limited, and for example, the determination is made based on information (bit) indicating a type and attribute of the mobile object, which is included in the mobile object information of the mobile object. Specifically, the mobile object information includes the information indicating the mobile object type, and the mobile object type can be determined as the pedestrian when the information indicates “0”, and determined as the vehicle when the information indicates “1”, for example.

Note that, although “0” is assigned when the mobile object is the mobile communication terminal (mobile phone), the case where the pedestrian rides in the vehicle is conceivable as described above. Accordingly, as described above in the fourth embodiment, the mobile phone 20 may be further configured to determine whether or not the pedestrian as the another mobile object is moving on foot (whether or not the pedestrian rides in the vehicle), and determine that the another mobile object is the pedestrian only when the mobile object type is the pedestrian and the pedestrian is moving on foot.

Then, when the control unit 1 determines that the another mobile object is not the pedestrian (that is, the another mobile object is the vehicle) (Step S54), the processing proceeds to Step S55, and when the field intensity is equal to larger than the threshold (that is, the mobile phone 20 and the vehicle (another communication device) are approaching each other), the mobile phone 20 gives a notification through the notification unit 10 (Step S56).

According to this embodiment, effects similar to those of the second embodiment are achieved. Further, when the mobile objects are the pedestrians (the mobile communication terminals), the mobile phone 20 does not transmit and/or receive the information. In other words, when the mobile objects approaching each other are the pedestrians, there is no need to notify the pedestrians of a risk that collision may occur the moment the pedestrians meet. In view of this, by limiting unnecessary transmission/reception of the information in such case, it is possible to reduce the power consumption.

### [Others]

Note that, in the first to third embodiments, the description has been given of the processing performed by the control unit 1 of the mobile phone 20 while taking the mobile phone 20 as an example of the mobile communication device, but those embodiments are similarly applicable to processing performed by a control unit of the in-vehicle communication device, such as a navigation device, mounted to the vehicle.

Accordingly, it can be said that the mobile communication device according to the first and second embodiments described above is a mobile communication device in which the control unit 1 determines whether or not the mobile object is moving based on the output of the movement detection sensor 9, and only when determining that the mobile object is moving, transmits and/or receives the information to and/or from the another communication device through the communication unit 8.

Moreover, it can be said that the mobile communication device according to the third embodiment described above is a mobile communication device in which the control unit 1 further determines whether or not the current position of the mobile object is near the intersection, and only when determining that the mobile object is moving and the current position of the mobile object is near the intersection, transmits and/or receives the information to and/or from the another communication device through the communication unit 8.

Further, the third to fifth embodiments may be combined with one another for use.

### INDUSTRIAL APPLICABILITY

The present invention is applicable to a mobile communication device and communication control method for performing predetermined control in order to prevent collision between mobile objects.

This application claims priority from Japanese Patent Application No. 2011-281819, filed on Dec. 22, 2011 in the Japan Patent Office, the entire disclosure of which is incorporated herein by reference.

### REFERENCE SIGNS LIST

1 control unit
2 display unit
3 operation unit
4 current position detection unit
5 speed detection unit
6 map information storage unit
7 battery
8 communication unit
9 movement detection sensor
10 notification unit
20 mobile phone

1. A mobile communication device, which is provided in a mobile object, comprising:
a movement detection sensor for detecting movement of the mobile object;
a communication unit for communicating to/from another communication device; and
a control unit for determining whether the mobile object is moving or not based on an output of the movement detection sensor,
wherein the control unit transmits and/or receives information to and/or from the another communication device through the communication unit only when determining that the mobile object is moving.

2. A mobile communication device according to claim 1, wherein the control unit further determines whether a current position of the mobile object is near an intersection or not, and transmits and/or receives the information to and/or from the another communication device through the communication unit only when the mobile object is moving and the current position of the mobile object is near the intersection.

3. A mobile communication device according to claim 1,
wherein the mobile object comprises a pedestrian, and
the control unit determines whether the pedestrian rides in a vehicle or not, and avoids the transmission and/or reception of the information to and/or from the another communication device through the communication unit irrespective of whether the pedestrian is moving or not when the pedestrian rides in the vehicle.

4. A mobile communication device according to claim 1,
wherein the mobile object comprises a pedestrian, and
the control unit determines whether the pedestrian is operating the mobile communication device or not, and avoids the transmission and/or reception of the information to and/or from the another communication device through the communication unit irrespective of whether the pedestrian is moving or not when the pedestrian is not operating the mobile communication device.

5. A mobile communication device according to claim 1, wherein the control unit gives, through a notification unit, a notification that there is a risk that the mobile object collides with another mobile object including the another communication device based on the information acquired from the another communication device through the communication unit.

6. A mobile communication device according to claim 1,
wherein the mobile object comprises a pedestrian, and
the control unit determines whether the another mobile object is the pedestrian or not, and avoids giving a notification that there is a risk that the mobile object collides with the another mobile object when the another mobile object is the pedestrian.

7. A mobile communication device according to claim 1, wherein the control unit stops feeding power to the communication unit, to thereby avoid the transmission and reception of the information to and from the another communication device through the communication unit.

8. A communication control method, comprising the steps of:
determining whether a mobile object is moving or not based on an output of a movement detection sensor for detecting movement of the mobile object; and
transmitting and/or receiving information to and/or from another communication device through a communication unit only when the mobile object is moving.
